(19) United States
(12) Patent Application Publication
(10) Pub. No.: US 2006/0259677 A1
(43) Pub. Date: Nov. 16, 2006

(54) Computer speaker apparatus and method using same

(76) Inventor: Joshua S. Rosenfield, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/128,456

(22) Filed: May 13, 2005

(51) Int. Cl. G06F 13/20

(52) U.S. Cl. 710/313

(57) ABSTRACT

A computer speaker apparatus is disclosed which comprises a speaker, signal processing circuitry interconnected with the speaker, and a housing, where the speaker and the signal processing circuitry are disposed in the housing. The computer speaker apparatus further comprises a connector capable of mating with a Universal Serial Bus or IEEE 1394 port, and a flexible support member having a first end and a second end, where the housing is rotatably disposed on the first end of the flexible support member, and where the connector is disposed on the second end of the flexible support member.

### FIELD OF THE INVENTION

The invention relates to a computer speaker apparatus and a method using that apparatus.

### BACKGROUND OF THE INVENTION

Various computer speaker assemblies are known in the art, where those assemblies include a plurality of separate components, such as cables, cords, plugs, speakers, and the like. What is needed is an integral, computer speaker apparatus which comprises a unitary apparatus having no external cables, cards, plugs, wires, and/or other components.

### SUMMARY OF THE INVENTION

Applicant's invention comprises a computer speaker apparatus. Applicant's computer speaker apparatus comprises a speaker, signal processing circuitry interconnected with the speaker, and a housing, where the speaker and the signal processing circuitry are disposed in the housing.

Applicant's computer speaker apparatus further comprises a flexible support member having a first end and a second end and a connector capable of mating with a Universal Serial Bus (“USB”) port or IEEE 1394 port, also known to those in the art as “firewire,” wherein the housing is rotatably disposed on the first end of the flexible support member, and wherein the connector is disposed on the second end of the flexible support member.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view showing Applicant's computer speaker apparatus;

FIG. 2A is a block diagram showing the components of Applicant's computer speaker apparatus;

FIG. 2B is a block diagram showing the components of Applicant's peripheral interface device;

FIG. 2C is a front view of a USB connector element of Applicant's apparatus;

FIG. 3 is a side view of a portable computer showing a USB/IEEE 1394 port;

FIG. 4A is a perspective view showing Applicant's computer speaker apparatus releaseably interconnected to a port disposed on the side of the computer of FIG. 3 wherein the visual display component is open;

FIG. 4B is a perspective view showing Applicant's computer speaker apparatus releaseably interconnected to a port disposed on the side of the computer of FIG. 3 wherein the visual display component is closed;

FIG. 5A is a perspective view showing a first orientation of Applicant's computer speaker apparatus releaseably interconnected to a port disposed on the rear portion of the computer of FIG. 3, wherein the visual display component of the computer is closed;

FIG. 5B is the perspective view of FIG. 5A wherein the visual display component of the computer is open;

FIG. 6 is a perspective view showing a second orientation of Applicant's computer speaker apparatus releaseably interconnected to a port disposed on the rear portion of the computer of FIG. 3;

FIG. 7 is a perspective view showing a third orientation of Applicant's computer speaker apparatus releaseably interconnected to a port disposed on the rear portion of the computer of FIG. 3;

FIG. 8 is a perspective view showing a fourth orientation of Applicant's computer speaker apparatus releaseably interconnected to a port disposed on the rear portion of the computer of FIG. 3;

FIG. 9 is a flow chart summarizing the steps of a method using Applicant's computer speaker apparatus; and

FIG. 10 is a perspective view showing Applicant's computer speaker apparatus releaseably interconnected to a port disposed on the front of a desktop computer.

### DETAILED DESCRIPTION OF THE PREFERRED EMBODIMENTS

This invention is described in preferred embodiments in the following description with reference to the Figures, in which like numbers represent the same or similar elements. In certain Figures, the invention is shown in combination with a portable computer. The following description of Applicant's apparatus and method is not meant, however, to limit Applicant's invention to use with portable computers, as the invention herein can be generally used in combination with any computing device.

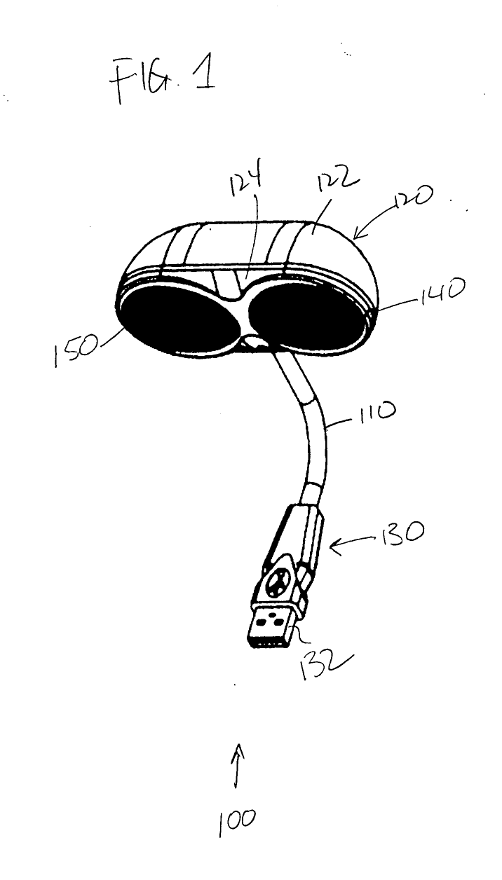

Referring now to FIG. 1, Applicant's computer speaker apparatus 100 comprises flexible support member 110, speaker assembly 120 rotatably disposed on a first end of flexible support member 110, and coupling means 130 disposed on a second end of flexible support member 110. A plurality of power conduits and communication links, described below, are disposed within flexible support member 110.

Speaker 140 and 150 are disposed within speaker assembly 120. As those skilled in the art will appreciate, a speaker comprises an electromechanical transducer. More specifically, a speaker converts electric energy (voltage and current) into mechanical energy (moving mass) which then vibrates air. The change of energy is performed by the interaction of a current with a permanent magnetic field, created using one or more stationary magnets.

As those skilled in the art will further appreciate, a speaker comprises a cone, a coil, a magnetic field apparatus, a suspension, and a frame. The cone comprises that portion of the speaker that pushes air to form sound. The cone is attached to the coil and pushed by the coil. The coil carries a current which interacts with a magnetic field created by the magnet. The coil is attached to the cone to push the cone up and down. The coil is disposed adjacent to the poles of the magnet. The motion of the cone is a function of the magnetic force placed upon it. The suspension connects the moving cone to the non-moving frame.

The force on a current-carrying wire is equal to the strength of the magnetic field times the current times the length of the wire according to the equation F=Bli. A speaker receives an input current from a source that is fed through the coil. The shape and resistance of the coil produce an electric field that interacts with a magnetic field already in place. The interaction between the two fields forces the coil to move vertically which pushes the cone. The cone, mounted to the speaker box with the suspension system, moves up and down, vibrating the air to create pressure differentials that are interpreted as sounds by the human ear.

In the illustrated embodiment of FIG. 1, speaker assembly 120 comprises a first housing portion 122 and a second housing portion 124. In other embodiments, housing portions 122 and 124 are integrally formed in a single unit. In certain embodiments, housing portion 122 is formed to include one or more air apertures to allow movement of air into and out of assembly 120.

In the illustrated embodiment of FIG. 1, housing portion 124 is formed to include two speaker apertures. The cone portion of speaker 140 is disposed within a first one of those speaker apertures. One or more magnets, the coil element, the suspension element, and the frame element, comprising speaker 140 are disposed within speaker assembly 120.

The cone portion of speaker 150 is disposed within a second one of the two speaker apertures in housing portion 124. One or more magnets, the coil element, the suspension element, and the frame element, comprising speaker 150 are disposed within speaker assembly 120.

In the illustrated embodiment of FIG. 1, speaker assembly 120 comprises two speakers, namely speaker 140 and speaker 150. In other embodiments of Applicant's apparatus, speaker assembly 120 comprises one speaker. In these embodiments, housing portion 124 is formed to include one aperture.

In yet other embodiments, Applicant's speaker assembly 120 comprises more than two speakers. As a general matter, if speaker assembly 120 comprises (n) speakers, then that assembly 120 is formed to include (n) speaker apertures, in optional combination with one or more smaller apertures disposed in the rear portion, i.e. in housing portion 122. In certain embodiments, Applicant's one or more speakers each comprise a product sold in commerce under the name AL3W by Meiyang Electronics, Dongguan China.

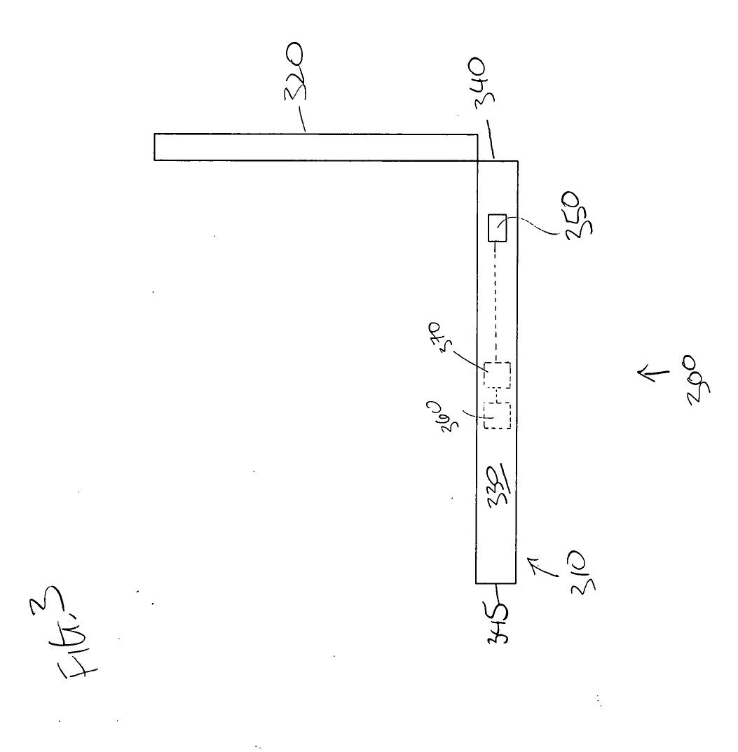

Referring now to FIG. 3, computer 300 comprises port 350. In the illustrated embodiment of FIG. 3, port 350 is disposed in a side portion 330 of chassis 310. In other embodiments, port 350 is disposed in a rear portion 340 of chassis 310. In other embodiments, port 350 is disposed in a front portion 345 of chassis 310.

Computer 300 further comprises processor 370. In certain embodiments, computer 300 further comprises instructions/functions 360 (collectively “software”) which are utilized by processor 370 to amplify the digital signals provided to port 350.

In certain embodiments, port 350 comprises a Universal Serial Bus (“USB”) connection. In certain embodiments, port 350 comprises a USB 1.0 connection. In other embodiments, port 350 comprises a USB 2.0 connection.

In certain embodiments, port 350 comprises an IEEE 1394 compliant connection. In certain embodiments, computer 300 comprises a plurality of ports 350, wherein one or more of those ports comprise USB ports and one or more of those ports comprise an IEEE 1394 port.

Referring again to FIG. 1, coupling means 130 comprises a male connector 132. In certain embodiments, connector 132 can be removeably disposed in a USB port 350 (FIG. 3), such that computer 300 is capable of providing power and one or more digital signals to Applicant's apparatus 100. In other embodiments, connector 132 can be removeably disposed in an IEEE 1394 port 350 (FIG. 3), such that computer 300 is capable of providing power and one or more digital signals to Applicant's apparatus 100.

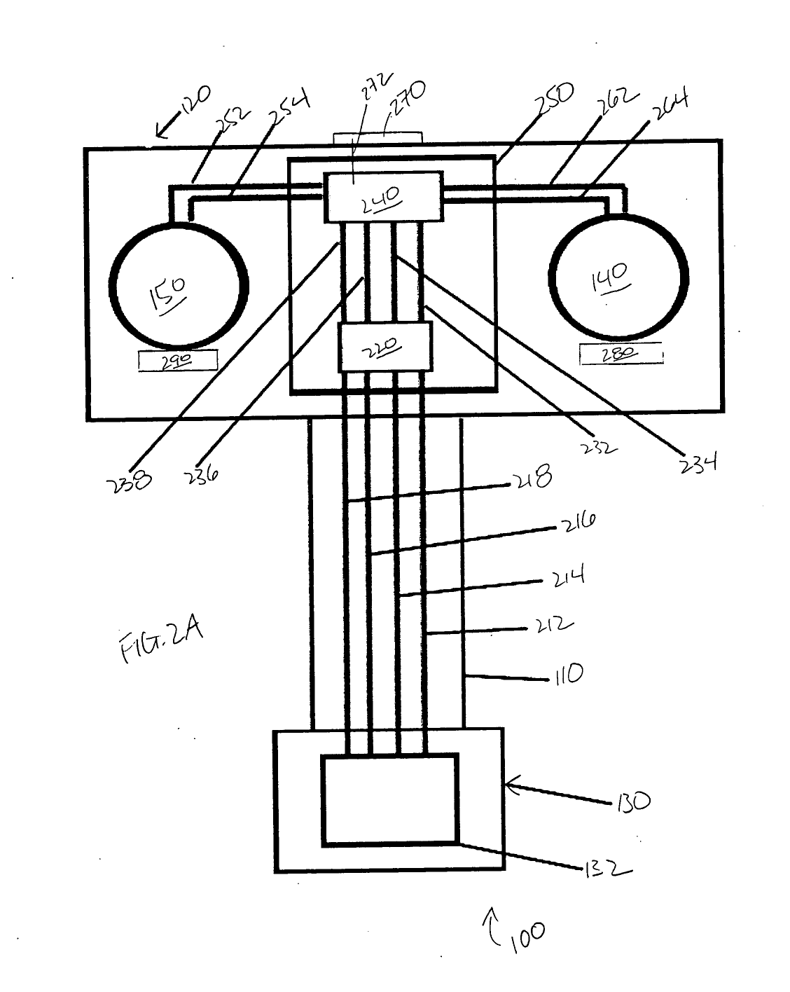

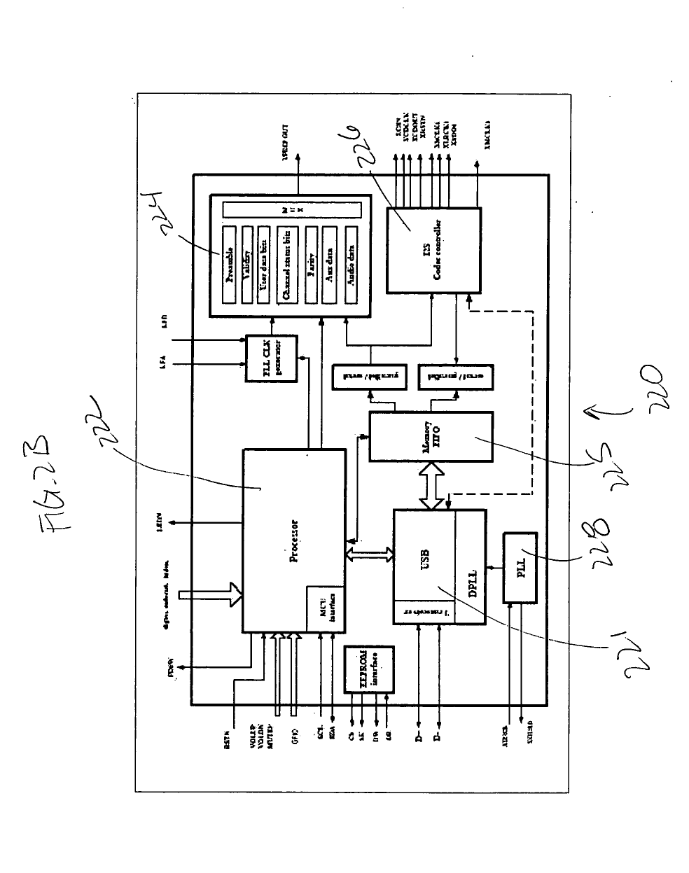

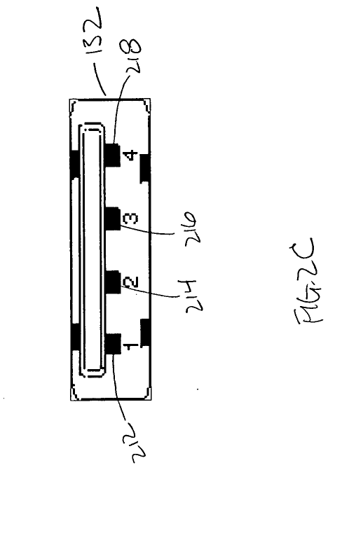

FIG. 2C shows a front view of a USB embodiment of connector 132 wherein connector 1 is interconnected with power conduit 212 (FIG. 2A), connector 2 is interconnected with first communication link 214 (FIG. 2A), connector 3 is interconnected with second communication link 216 (FIG. 2A), and connector 4 is interconnected with electrical ground 218.

Referring now to FIG. 2A, Applicant's apparatus 100 comprises signal processing circuitry 240. In certain embodiments, signal processing circuitry is disposed on circuit board 250. Applicant's signal processing circuitry 240 filters noise from the one or more signals provided by the interconnected computer, removes interference, amplifies certain frequencies and suppresses other frequencies.

In certain embodiments, Applicant's signal processing circuitry 240 comprises a digital to analog converter (“DAC”). In certain embodiments, Applicant's signal processing circuitry 240 further comprises an amplifier in combination with a DAC.

In certain embodiments, Applicant's signal processing circuitry 240 comprises a switch-mode power supply wherein audio signals are used to modulate the switching action. Using audio signals for pulse width modulation in a switch-mode power supply allows high power amplification using nominal voltages and small components, such that sufficient power can be provided to Applicant's signal processing circuitry 240 through flexible support member 110, and such that Applicant's signal processing circuitry 240 can be disposed within speaker assembly 120.

In certain embodiments, Applicant's signal processing circuitry 240 comprises an integrated circuit (“IC”) sold in commerce under the name B12008 by Biforst Technology, Inc., 8F-3, No. 26 Tai Yuen St., Jubei City, Hsin-Chu, Taiwan, R.O.C.

In certain embodiments, Applicant's computer speaker apparatus 100 further comprises a volume control 270 disposed on speaker assembly 120. Volume control 270 is interconnected with Applicant's signal processing circuitry via one or more communication links 272. As described above, in certain embodiments Applicant's apparatus 100 further comprises software 360, wherein that software comprises a volume control function, in optional combination with an equalizer function. Software 360 allows the user to cause the host computer to amplify, i.e. boost, the digital signals provided to Applicant's apparatus. As those skilled in the art will appreciate, an equalizer permits separately adjusting the volume of different frequency portions of an audio signal.

In certain embodiments, the user is able to adjust the volume of the sound emitted by Applicant's speaker apparatus using volume control 270, software 360, or both.

In certain embodiments, signal processing circuitry 240 receives a first digital signal from an interconnected USB interface device, such as for example interface device 220 (FIGS. 2A, 2B), via communication link 234, and a second digital signal from that interconnected interface device via communication link 236. In certain embodiments, signal processing circuitry 240 receives power from the interconnected USB interface device via power conduit 232, and an electrical ground comprising power conduit 238. In certain embodiments, the power is +5 volts. In other embodiments, the power is +12 volts.

Referring now to FIG. 2B, in certain embodiments interface device 220 comprises a USB transceiver 221 which supports 12 Mb/s data rate (full speed). In certain embodiments, Applicant's device 220 further comprises a micro-controller unit (MCU) 222. In certain embodiments, MCU 222 comprises an 8052 8-bit core, 8 K bytes of program memory ROM that contains a boot loader program and a library of commonly used USB functions, 6016 bytes of program memory RAM which is loaded by the boot loader program, 256 bytes of internal data memory RAM, two GPIO ports. Applicant's MCU 222 handles all USB control, interrupt, and bulk endpoint transfers.

In certain embodiments, Applicant's device 222 further comprises a direct memory access (“DMA”) controller 224. In certain embodiments, device 220 comprises a circular programmable FIFO 225 used for isochronous audio data streaming in combination with two DMA channels to support streaming USB audio data to/from the codec port interface, wherein each channel can support a single USB isochronous endpoint.

In certain embodiments, Applicant's device 220 further comprises a Codec Port Interface 226. In certain embodiments, Applicant's Codec Port Interface 226 is configurable to support AC'97 1.X, AC'97 2.X, AIC or I²S serial interface formats and can support bulk data transfer using DMA for higher throughput. In certain embodiments, Applicant's device 220 further comprises a phase-locked loop (PLL) 228 wherein an internal oscillator is used to generate internal clocks from a 6 MHz crystal input.

In certain embodiments, Applicant's USB interface device 220 comprises a product sold in commerce under the name SN1121ASF by Sonix Technology, Ltd., 9F, No. 8, Lane 32, Hsien Cheng 5th Street, Chupei City, Hsinchu, Taiwan.

Referring again to FIG. 2A, interface device 220 receives a first digital signal from an interconnected computer, such as for example computer 300 (FIG. 3), via communication link 214, and a second digital signal from that interconnected computer via communication link 216. In certain embodiments, interface device 220 receives power from an interconnected computer, such as for example computer 300 (FIG. 3), via power conduit 212, and an electrical ground comprising power conduit 218. In certain embodiments, the power is +5 volts. In certain embodiments, the power is +12 volts.

Power conduits 212 and 218, and communication links 214 and 216, are disposed within flexible support member 110. In certain embodiments, flexible support member 110 comprises a flexible cable sold in commerce under the name FC2 by Meiyang Electronics, Dongguan China. Flexible support member 110 can be configured into two portions, where the angle between those two portions is variable between 0 degrees and 270 degrees.

Communication links 252 and 254 interconnect signal processing circuitry 240 and speaker 150. Communication links 252 and 254 provides the input current to the coil portion of speaker 150.

Communication links 262 and 264 interconnect signal processing circuitry 240 and speaker 140. Communication links 262 and 264 provides the input current to the coil portion of speaker 140.

In certain embodiments, speakers 140 and 150 are magnetically shielded to neutralize electromagnetic output. In certain embodiments, Applicant's apparatus further comprises one or more magnets 280 positioned behind the magnet element of speaker 140. In certain embodiments, Applicant's apparatus further comprises one or more magnets 290 positioned behind the magnet element of speaker 150.

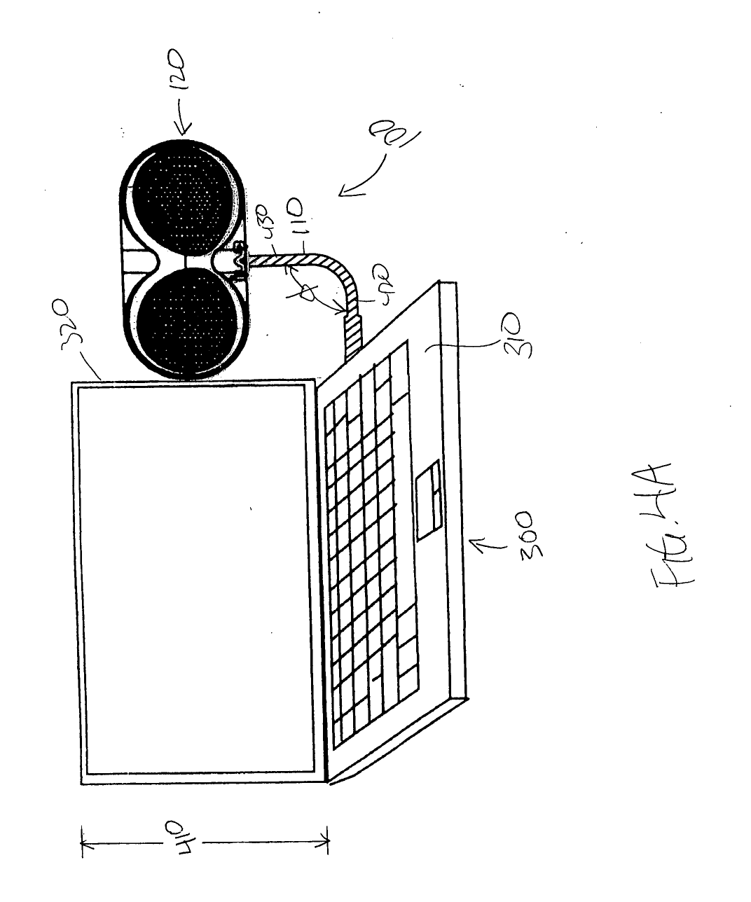

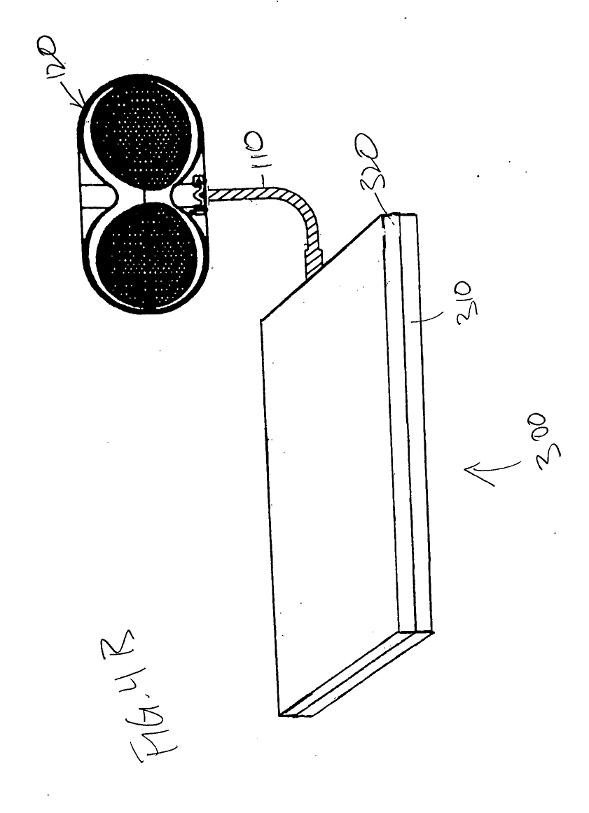

The illustrated embodiment of FIG. 4A shows Applicant's apparatus 100 releaseably interconnected with computer 300 wherein visual display component 320 is “open,” i.e. component 320 has been rotated about 90 degrees upwardly from chassis 310. In the illustrated embodiment of FIG. 4A, connector portion 132 (FIG. 1) has been removeably inserted into port 350 (FIG. 3), and flexible support member 110 has been configured into two portions, namely, portion 420 and portion 430, wherein portion 420 is substantially perpendicular to portion 430, i.e. such that angle Φ is about 90 degrees. Flexible support member 110 is formed such that it can be reversibly configured to have an angle Φ having a value between 0 degrees and about 270 degrees. FIG. 4B shows the apparatus of FIG. 4A with the visual display component 320 in a closed orientation.

In the illustrated embodiments of FIGS. 4A and 4B, speaker housing 120 has been rotated about 90 degrees from the orientation shown in FIG. 1. Speaker housing 120 is rotatably disposed on support member such that housing 120 can be reversibly rotated about plus or minus 180 degrees from the orientation shown in FIG. 1.

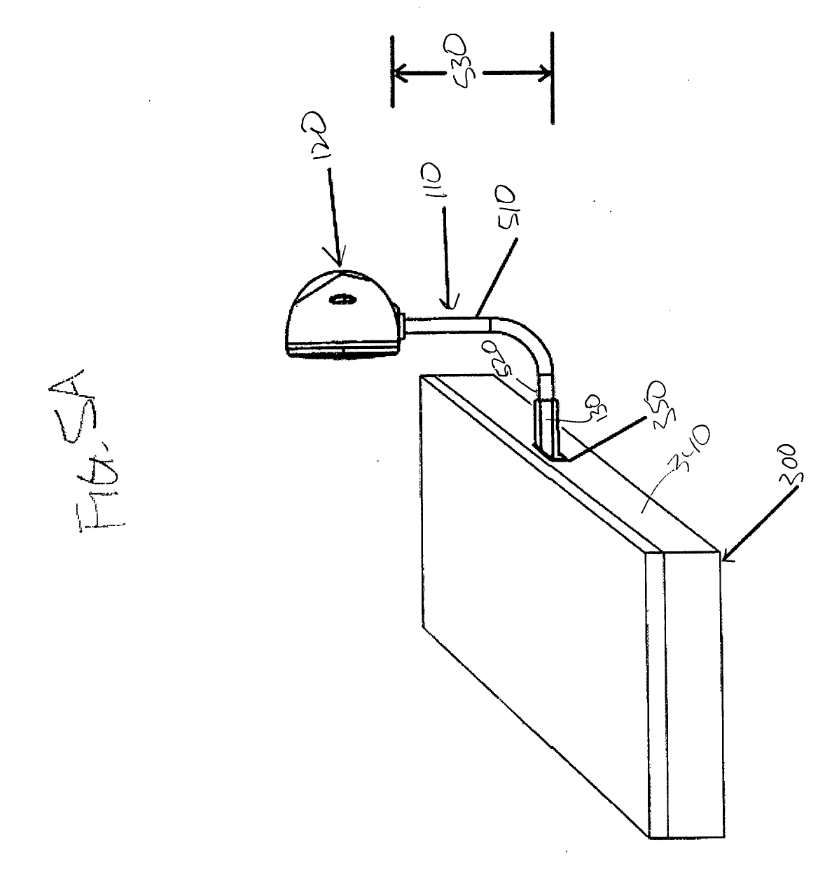

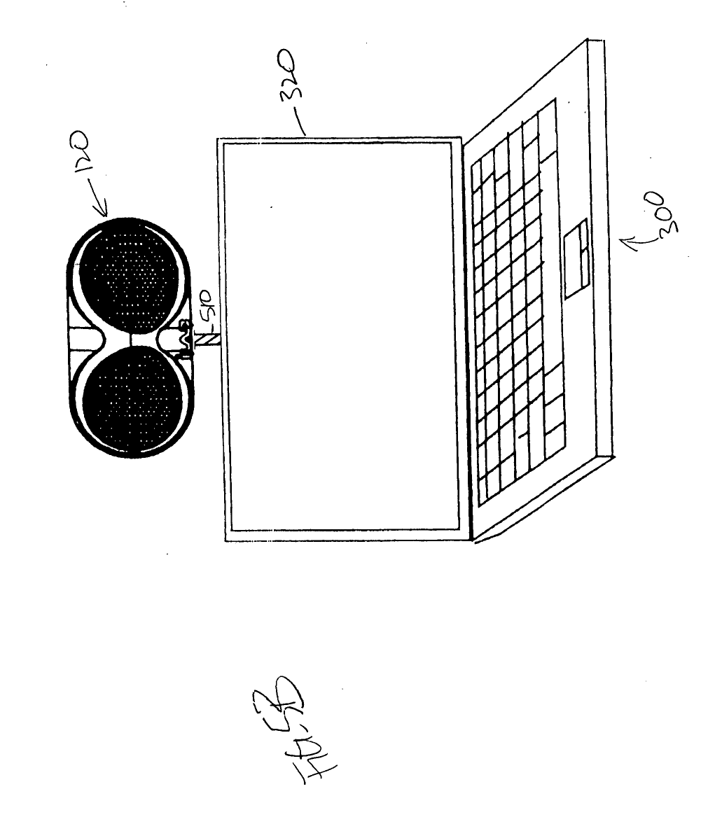

In the illustrated embodiment of FIG. 5A, apparatus 100 is releaseably attached to computer 300 by removeably inserting connector 132 (FIGS. 1, 2) into port 350 disposed on the rear portion 340 of computer 300. In the illustrated embodiment of FIG. 5A, speaker housing 120 has the orientation with respect to connection means 130 shown in FIG. 1. Further in the illustrated embodiment of FIG. 5A, flexible support member 110 is configured into two portions 510 and 520 such that portion 510 is substantially perpendicular to portion 520, and such that portion 510 has length 530.

Referring again to FIG. 4A, visual display element 320 of computer 300 has a height 410 when element 320 is disposed substantially perpendicular to chassis 310. In certain embodiments, height 530 (FIG. 5A) is greater than height 410 (FIG. 4). In the illustrated embodiment of FIG. 5B, visual display element 320 has been rotated upwardly into an “open” position. Because length 530 (FIG. 5A) is greater than height 410 (FIG. 4), speaker housing 120 is disposed above the top of display device 320 in the illustrated embodiment of FIG. 5B.

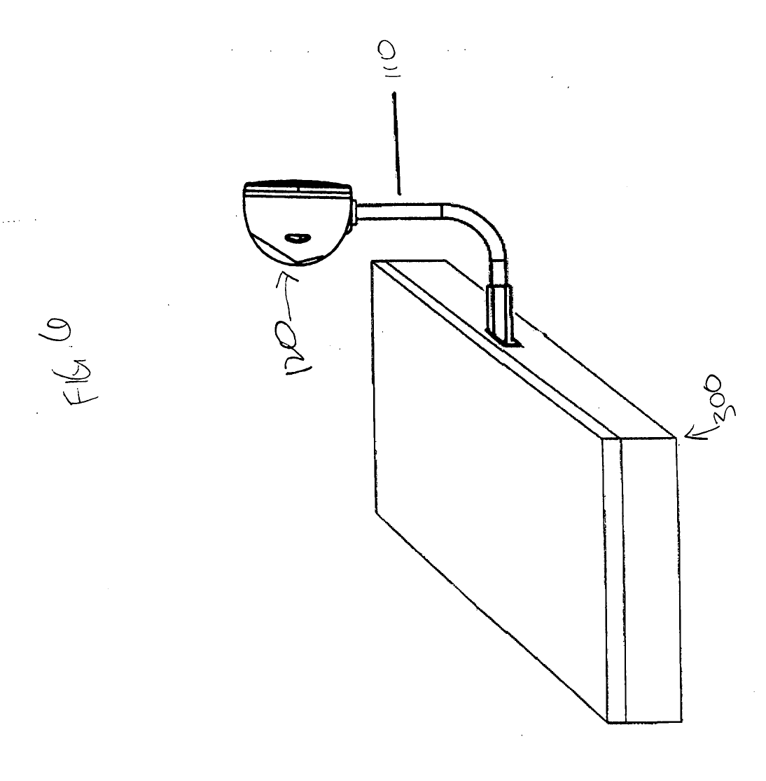

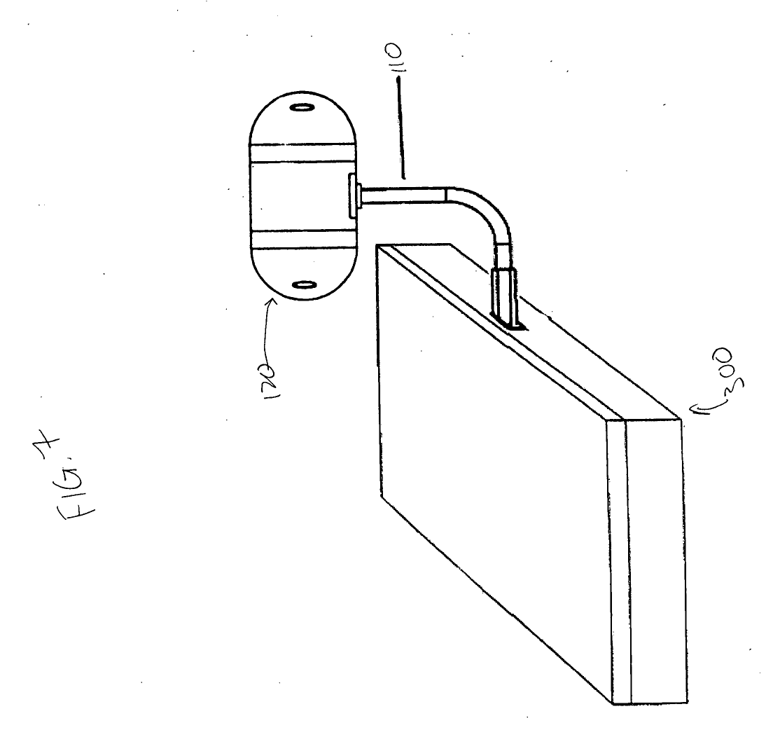

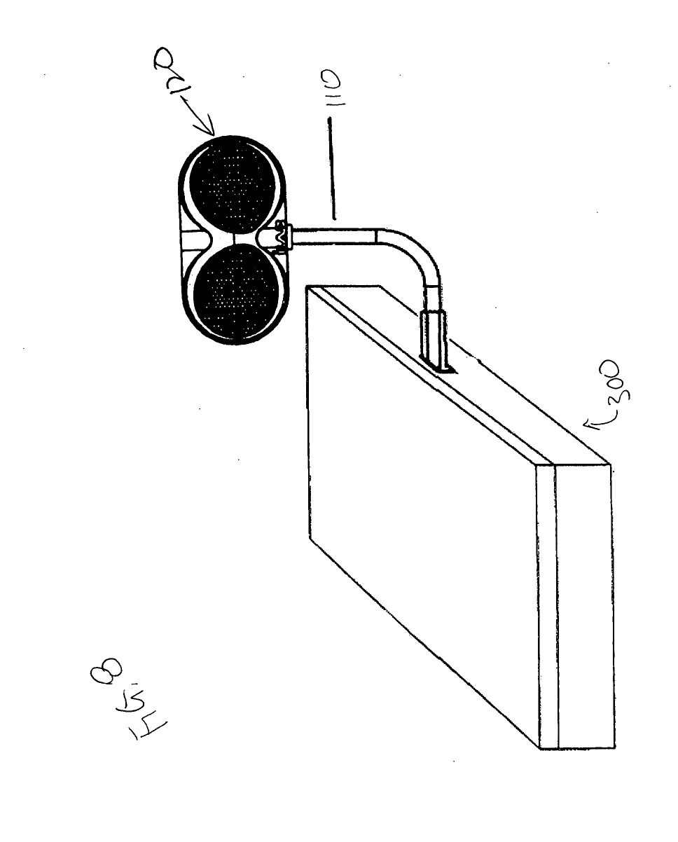

In the illustrated embodiment of FIG. 6, speaker housing 120 is rotated about 180 degrees from the orientation shown in FIG. 5A. In the illustrated embodiment of FIG. 7, speaker housing 120 is rotated about 90 degrees in a first direction from the orientation shown in FIG. 5A. In the illustrated embodiment of FIG. 8, speaker housing 120 is rotated about 90 degrees in a second direction from the orientation shown in FIG. 5A.

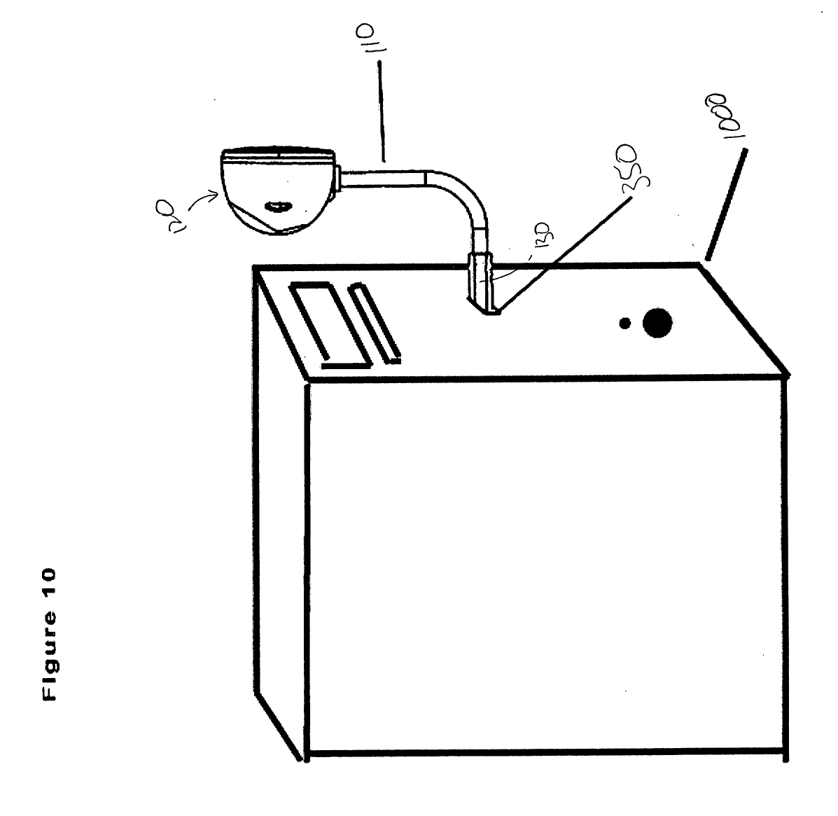

FIG. 10 shows Applicant's computer speaker apparatus 100 releaseably interconnected to desktop computer 1000. In the illustrated embodiment of FIG. 10, speaker assembly 120 is rotated 180 from the orientation shown in FIG. 1.

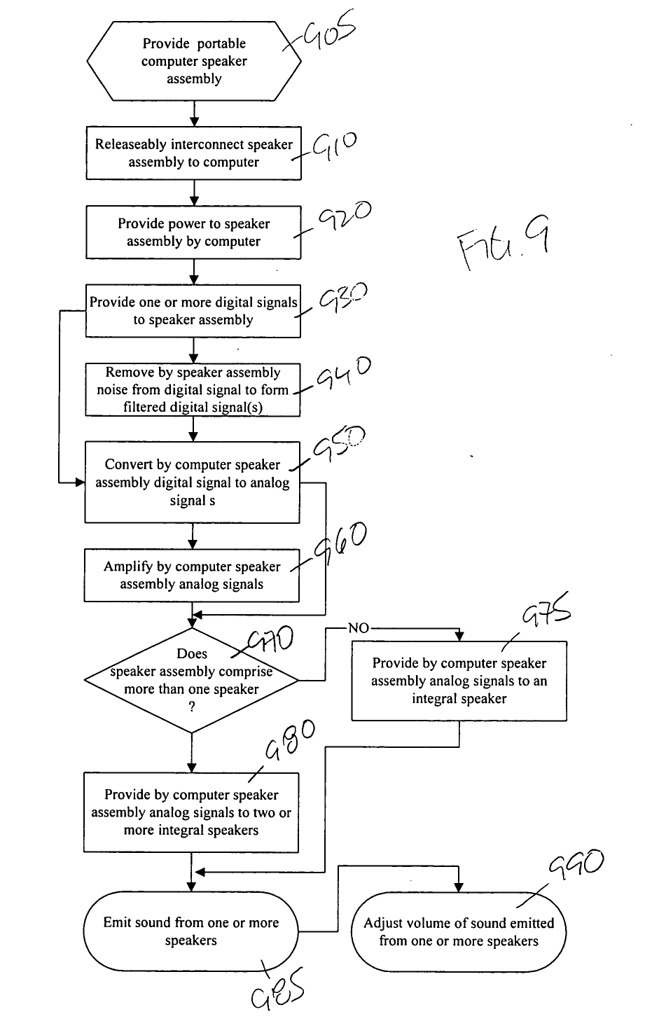

Applicant's invention includes a method to emit audible information, i.e. sound, using Applicant's apparatus. FIG. 9 summarizes the steps of Applicant's method. Referring now to FIG. 9, in step 905 the method provides an integral computer speaker apparatus. By “integral apparatus,” Applicant means a one-piece assembly comprising no external cables, cords, or wall plugs. In certain embodiments, the computer speaker apparatus of step 905 comprises Applicant's apparatus 100 (FIGS. 1, 2), and as described herein.

In certain embodiments, Applicant's integral computer speaker apparatus comprises a first speaker, a second speaker, a housing, wherein the first speaker and the second speaker are disposed in the housing, a flexible support member having a first end and a second end, a connector disposed on the second end of the flexible support member and capable of mating with a USB or IEEE 1394 port, one or more power conduits disposed within the flexible support member interconnecting the connector and one or more components disposed in the housing, one or more communication links disposed within the flexible support member interconnecting the connector and one or more components disposed in the housing, wherein the housing is rotatably disposed on the first end of said flexible support member.

In step 910, the method provides a computer, and releaseably interconnects the computer speaker apparatus of step 905 to that computer. In certain embodiments, the computer of step 910 comprises a portable, i.e. “laptop,” computer. In other embodiments, the computer of step 910 comprises a personal computer, a mainframe computer, a workstation, combinations thereof, and the like. In certain embodiments, step 910 comprises inserting a connector disposed on the computer speaker apparatus, such as connector 132 (FIG. 1), into an appropriate port, such as port 350 (FIG. 3), on the computer of step 910, such as computer 300 (FIG. 3). In certain embodiments, that connector and that port comprise compatible USB devices. In other embodiments, that connector and that port comprise compatible IEEE 1394 devices.

In certain embodiments, step 910 further comprises rotating the housing portion, such as housing 120, of Applicant's apparatus 100 up to plus or minus 180 degrees around the flexible support member, such as flexible support member 110. In certain embodiments, step 910 further comprises configuring the flexible support member into two portions wherein the angle supporting the first portion and the second portion is between 0 degrees and 270 degrees. In certain embodiments, step 910 further comprises both rotating the housing portion, and configuring the flexible support member portion.

In step 920, the computer provides power to the releaseably interconnected computer speaker apparatus. In certain embodiments, step 920 comprises providing +5 volts to Applicant's computer speaker apparatus. In certain embodiments, step 920 comprises providing +12 volts to Applicant's computer speaker apparatus.

In certain embodiments, the portable computer speaker apparatus of step 905 comprises signal processing circuitry, such as signal processing circuitry 240 as described herein. In these embodiments, step 920 comprises providing power, as described herein, to signal processing circuitry 240.

In certain embodiments, the computer speaker apparatus of step 905 further comprises a peripheral interface device, such as device 220 as described herein. In these embodiments, step 920 comprises providing power, as described herein, to peripheral interface device 220.

In step 930, the interconnected computer provides one or more digital signals to Applicant's signal processing circuitry via the one or more communication links. In certain embodiments, Applicant's signal processing circuitry comprises a switch-mode power supply using the digital signals of step 930 to provide pulse width modulation. In certain embodiments, that digital signal comprises noise. In certain embodiments, Applicant's method transitions from step 930 to step 950.

In certain embodiments, Applicant's method transitions from step 930 to step 940, wherein Applicant's signal processing circuitry filters substantially all the noise from the digital signal. Applicant's method transitions from step 940 to step 950 wherein Applicant's signal processing circuitry converts the one or more digital signals to one or more analog signals. In certain embodiments, Applicant's method transitions from step 950 to step 970.

In certain embodiments, the computer speaker apparatus of step 905 further comprises an amplifier disposed in the speaker housing. In certain embodiments, Applicant's amplifier comprises a Class D amplifier. In Applicant's amplifier embodiments, Applicant's method transitions from step 950 to step 960 wherein the method amplifies the analog signal of step 950. Applicant's method transitions from step 960 to step 970.

If the computer speaker apparatus of step 905 comprises one speaker, then the method transitions from step 960 through step 970 to step 975 wherein the method provides one or more analog signals, optionally one or more amplified analog signals to that speaker. Applicant's method transitions from step 975 to step 985.

If the computer speaker apparatus of step 905 comprises more than one speaker, then the method transitions from step 960 through step 970 to step 980 wherein Applicant's method provides one or more analog signals, optionally one or more amplified analog signals, to two or more speakers disposed within Applicant's speaker assembly. Applicant's method transitions from step 980 to step 985 wherein sound is emitted from one or more speakers disposed in Applicant's speaker apparatus.

In certain embodiments, Applicant's method includes step 990 wherein the method adjusts the volume of the sound emitted from one or more speakers disposed in Applicant's speaker apparatus. In certain embodiments, step 990 comprises adjusting an external switch, such as switch 270 (FIG. 2), disposed on Applicant's speaker apparatus. In certain embodiments, step 990 comprises adjusting the volume of the emitted sound using one or more software applications, such as instructions/functions 360 (FIG. 3), disposed on the host computer. In certain embodiments, step 990 comprises adjusting an external switch, such as switch 270 (FIG. 2), disposed on Applicant's speaker apparatus in combination with adjusting the volume of the emitted sound using one or more software applications, such as instructions/functions 370 (FIG. 3), disposed on the host computer.

While the preferred embodiments of the present invention have been illustrated in detail, it should be apparent that modifications and adaptations to those embodiments might occur to one skilled in the art without departing from the scope of the present invention as set forth in the following claims.

I claim:

1. A computer speaker apparatus, comprising:
a speaker;
a housing, wherein said speaker is disposed in said housing;
signal processing circuitry disposed in said housing and interconnected with said speaker;
a flexible support member having a first end and a second end;
a connector capable of mating with a USB or IEEE 1394 port;
one or more power conduits interconnecting said signal processing circuitry and said connector, wherein said one or more power conduits are disposed within said flexible support member;
one or more communication links interconnecting said connector and said signal processing circuitry, wherein said one or more communication links are disposed within said flexible support member;
wherein said housing is rotatably disposed on said first end of said flexible support member, and wherein said connector is disposed on said second end of said flexible support member.

2. The computer speaker apparatus of claim 1, wherein:
said housing can be rotated plus or minus 180 degrees around said first end of said flexible support member; and
said flexible support member can be reversibly configured to comprise two portions, wherein the angle between said two portions can be adjusted from 0 degrees to 270 degrees.

3. The computer speaker apparatus of claim 1, wherein said signal processing circuitry comprises a switch-mode power supply wherein audio signals are used for pulse width modulation.

4. The computer speaker apparatus of claim 3, further comprising a peripheral interface device interconnected with said one or more power conduits and with said one or more communication links and interconnected with said signal processing circuitry, wherein said peripheral interface device is disposed within said housing.

5. The computer speaker apparatus of claim 4, wherein said peripheral interface device comprises:
a USB transceiver;
a processor;
a direct memory access controller;
a codec port interface; and
a phase lock loop.

6. A computer speaker apparatus, comprising:
a first speaker;
a second speaker;
signal processing circuitry interconnected with said first speaker and with said second speaker;
a flexible support member having a first end and a second end;
a connector capable of mating with a USB or IEEE 1394 port, wherein said connector is disposed on said second end of said flexible support member;
a housing, wherein said first speaker, said second speaker, and said signal processing circuitry are disposed in said housing, wherein said housing is rotatably disposed on said first end of said flexible support member;
one or more power conduits interconnecting said signal processing circuitry and said connector, wherein said one or more power conduits are disposed within said flexible support member;
one or more communication links interconnecting said connector and said signal processing circuitry, wherein said one or more communication links are disposed within said flexible support member.

7. The computer speaker apparatus of claim 6, wherein:
said housing can be rotated plus or minus 180 degrees around said first end of said flexible support member; and
said flexible support member can be reversibly configured to comprise two portions, wherein the angle between said two portions can be adjusted from 0 degrees to 270 degrees.

8. The computer speaker apparatus of claim 6, wherein said signal processing circuitry comprises a switch-mode power supply wherein audio signals are used for pulse width modulation.

9. The computer speaker apparatus of claim 8, wherein said signal processing circuitry comprises a Class D amplifier.

10. The computer speaker apparatus of claim 8, wherein said signal processing circuitry further comprises a digital to analog converter.

11. The computer speaker apparatus of claim 6, further comprising a peripheral interface device interconnected with said one or more power conduits and with said one or more communication links and interconnected with said signal processing circuitry, wherein said peripheral interface device is disposed within said housing.

12. The computer speaker apparatus of claim 11, wherein said peripheral interface device comprises:
a USB transceiver;
a processor;
a direct memory access controller;
a codec port interface; and
a phase lock loop.

13. A method to provide audible information, comprising the steps of:
supplying a one-piece portable computer speaker apparatus comprising a first speaker, a second speaker, a housing, signal processing circuitry, a flexible support member having a first end and a second end, a connector disposed on said second end of the flexible support member and capable of mating with a USB or IEEE 1394 port, one or more power conduits disposed within said flexible support member interconnecting said connector and said signal processing circuitry, one or more communication links disposed within said flexible support member interconnecting said connector and said signal processing circuitry, wherein said first speaker, said second speaker, and said signal processing circuitry are disposed in said housing, and wherein said housing is rotatably disposed on said first end of said flexible support member;
releaseably interconnecting said computer speaker apparatus to a computer;
providing power from said computer to said computer speaker apparatus;
providing one or more digital signals from said computer to said computer speaker apparatus;
converting said one or more digital signals to one or more analog signal by said computer speaker apparatus;
providing said one or more analog signals to said first speaker; and
providing said one or more analog signals to said second speaker.

14. The method of claim 13, further comprising the step of filtering said one or more digital signals by said signal processing circuitry.

15. The method of claim 13, wherein said supplying step further comprises supplying signal processing circuitry comprising a digital to analog converter.

16. The method of claim 15 wherein said supplying step further comprises supplying signal processing circuitry comprising a switch-mode power supply wherein one or more digital signals are used for pulse width modulation.

17. The method of claim 16, wherein said supplying step further comprises supplying signal processing circuitry comprising a Class D amplifier, said method further comprising the steps of amplifying said one or more analog signals.

18. The method of claim 13, wherein said supplying step further comprises supplying a speaker apparatus comprising a peripheral interface device disposed in said housing and interconnected with said connector and with said signal processing circuitry.

19. The method of claim 13, wherein said supplying step further comprises supplying a peripheral interface device comprising:
a USB transceiver;
a processor;
a direct memory access controller;
a codec port interface; and
a phase lock loop.

20. The method of claim 13, further comprising the steps of:
rotating said housing up to plus or minus 180 degrees around said first end of said flexible support member; and
configuring said flexible support member to comprise a first component and a second component, wherein the angle between said first component and said second component is greater than 0 degrees and less than about 270 degrees.
